(19) United States
(12) Patent Application Publication
(10) Pub. No.: US 2007/0126581 A1
(43) Pub. Date: Jun. 7, 2007

(54) Method and apparatus for providing presence information using radio frequency identification technique

(75) Inventors: Kisoon Sung, Daejeon-city (KR); Hyung Hwan Kim, Daejeon-city (KR); Young Il Choi, Daejeon-city (KR); Byung Sun Lee, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/634,998

(22) Filed: Dec. 7, 2006

(30) Foreign Application Priority Data
Dec. 7, 2005 (KR) 10-2005-0118945
Jan. 6, 2006 (KR) 10-2006-0049272

(51) Int. Cl. G08B 13/14; G08B 23/00; G08B 5/22

(52) U.S. Cl. 340/572.1; 340/825.49; 340/573.4

(57) ABSTRACT

Provided are a presence information providing apparatus and method including an information requiring unit receiving identification information stored in a Radio Frequency Identification (RFID) tag located in a communication region of an RFID reader from the RFID reader belonging to a subscriber, and acquiring a subscriber's presence information based on the identification information; and an information providing unit providing the subscriber's presence information acquired by the information acquiring unit when a request for an authorized subscriber's information is received.

### CROSS-REFERENCE TO RELATED PATENT APPLICATION

This application claims the benefit of Korean Patent Application No.10-2005-0118945, filed on Dec. 7, 2005 and Korean Patent Application No.10-2006-0049272, filed on Jun. 1, 2006, in the Korean Intellectual Property Office, the disclosures of which are incorporated herein in their entirety by reference.

### BACKGROUND OF THE INVENTION

1. Field of the Invention

The present invention relates to a method and apparatus for providing presence information, and more particularly, to a presence information providing method and apparatus for acquiring presence information directly from a network by combining a Radio Frequency IDentification (RFID) technique with a presence open service.

2. Description of the Related Art

In general, a presence open service is a service which allows a subscriber to register and update his or her presence information, and provides an authorized subscriber's presence information if a request for presence information is issued. Here, the subscriber's presence information includes the subscriber's activity, location, privacy information, communication means information, etc.

The presence information can be classified mainly into two types of information, that is, static information and dynamic information. The static information refers to information which is provided as original information registered by the subscriber. The dynamic information refers to information which is provided by acquiring the subscriber's status information directly from a network.

For example, information about communication means (for example, a general telephone) connected to a network that does not provide a subscriber's activity, location, privacy information, or status information is static information.

Such static information is provided in its original form, i.e., as information registered by a subscriber. Therefore, if a subscriber does not update presence information when the subscriber's activity, location, or privacy information abruptly changes or when a general telephone, etc. cannot be used, wrong presence information can be provided.

As such, in the conventional presence open service, static information cannot be ensured as the latest correct information, without a subscriber's active update.

### SUMMARY OF THE INVENTION

The present invention provides a presence information providing apparatus and method which are capable of acquiring presence information directly from a network by introducing a Radio Frequency Identification (RFID) technique to an existing presence open service, and collecting the latest correct presence information, thereby providing various reliable presence open services based on the latest correct presence information.

According to an aspect of the present invention, there is provided a presence information providing apparatus including: an information requiring unit receiving identification information stored in an RFID (Radio Frequency IDentification) tag from the RFID reader belonging to a subscriber, and acquiring a subscriber's presence information based on the identification information; and an information providing unit providing the subscriber's presence information acquired by the information acquiring unit when a request for an authorized subscriber's information is received.

According to another aspect of the present invention, there is provided a presence information providing method including: receiving identification information stored in an RFID tag from the RFID reader belonging to a subscriber, and acquiring a subscriber's presence information based on the identification information; and providing the subscriber's presence information acquired by the information acquiring unit when a request for an authorized subscriber's information is received.

According to another aspect of the present invention, there is provided a presence information providing system including: an RFID host receiving identification information stored in an RFID tag from the RFID reader belonging to a subscriber, and acquiring a subscriber's presence information based on the identification information; and an open service gateway providing the subscriber's presence information acquired by the RFID host when a request for an authorized subscriber's information is received.

Therefore, the presence information providing apparatus and method can collect the latest correct presence information and provide reliable presence open services based on the latest correct presence information by acquiring a subscriber's presence information directly from a network. Hereinafter, a presence open type service will be schematically described.

The term “presence” generally means “existence/attendance/being” as defined in a dictionary. In the communication service field, the term “presence” generally represents the status of an object, and presence in a present communication service includes ON/OFF information of objects, and status information of the objects, such as conditions, descriptions, and location information, etc. commonly used in programs including an instant messenger, etc.

The presence open service is provided by an open service gateway which will be described in detail in relation to the following drawings, and manages and controls presence for resources on a wired/wireless/Internet network.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of an apparatus for providing presence information using a Radio Frequency IDentification (RFID) technique, according to an embodiment of the present invention;

FIG. 2 is a flowchart illustrating a method of providing presence information using the RFID technique, according to an embodiment of the present invention;

FIG. 3 illustrates a structure of a wired/wireless/Internet integrated network for providing presence information using the RFID technique;

FIG. 4 illustrates a wired/wireless/Internet integrated network system for providing presence information using the RFID technique; and

FIG. 5 is a view for explaining a method of providing presence information using an open service interface and the RFID technique.

### DETAILED DESCRIPTION OF THE INVENTION

Hereinafter, a presence information providing apparatus and method according to the present invention will be described in detail with reference to the attached drawings.

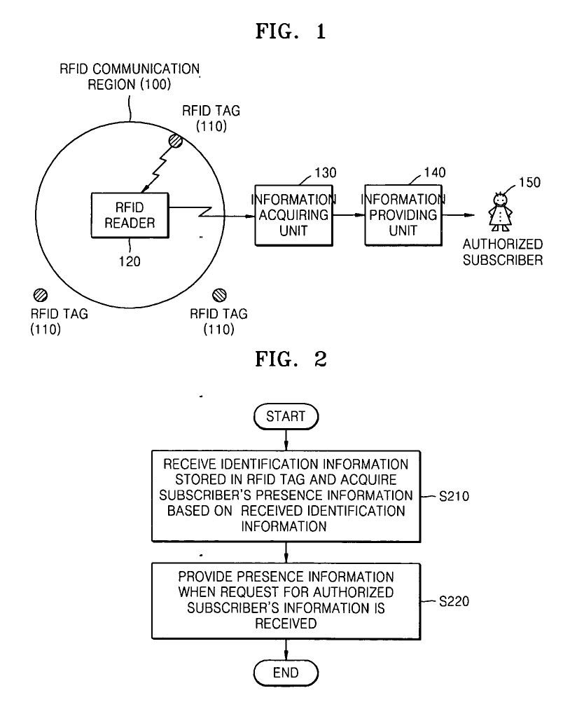

FIG. 1 illustrates a configuration of an apparatus for providing presence information using a Radio Frequency IDentification (RFID) technique, according to an embodiment of the present invention.

Referring to FIG. 1, the presence information providing apparatus includes a plurality of RFID tags 110, an RFID reader 120, an information acquiring unit 120, and an information providing unit 130.

The plurality of RFID tags 110 are distributed to arbitrary locations or communication devices. Identification information stored in each RFID tag 110 is location information if the RFID tag 110 is attached to a location (for example, a building), and is a number of a communication device if the RFID tag 110 is attached to a communication device.

The RFID reader 120 acquires the identification information stored in the RFID tag 110 from the RFID tag 110. The RFID reader 120 belongs to a subscriber. The RFID reader 120 reads RFID identification information stored in an RFID tag 110 located in its communication region.

The information acquiring unit 130 receives the identification information stored in the RFID tag 110 from the RFID reader 120. Information about communication means connected to a network that does not provide status information, a subscriber's activity, location, and privacy information is static presence information which cannot be provided directly from the network. Such static presence information must be registered or updated directly by a subscriber.

The present invention is aimed at converting static presence information which must be registered or updated by a subscriber into dynamic presence information which can be directly acquired from a network.

In order to perform this conversion, in an embodiment of the present invention, a plurality of RFID tags 110 are distributed to presence information objects, that is, locations or communication devices. An RFID tag 110 attached to a location stores location information. An RFID tag 110 attached to a communication device stores a number of the communication device.

The RFID reader 120 acquires the location information or the communication device information from the RFID tag 110 and transmits the location information or the communication device information to the information acquiring unit 130.

The information providing unit 140 provides subscriber's presence information to authorized subscribers.

In an embodiment of the present invention, the presence information is a subscriber's location or a number of an available communication device.

FIG. 2 is a flowchart illustrating a method of providing presence information using the RFID technique, according to an embodiment of the present invention.

Referring to FIG. 2, an RFID reader belonging to a subscriber receives identification information stored in an RFID tag located in its communication region. The subscriber's presence information is acquired on the basis of the identification information (operation S210). The subscriber's location information is obtained from an RFID tag attached to a location, and the subscriber's communication device number is obtained from an RFID tag attached to a communication device.

If a request for presence information is received from another party authorized by the subscriber, the subscriber's presence information is provided to the other party (operation S220). This process is performed so as to prevent the subscriber's privacy concerns from being invaded when the presence information is reckless provided.

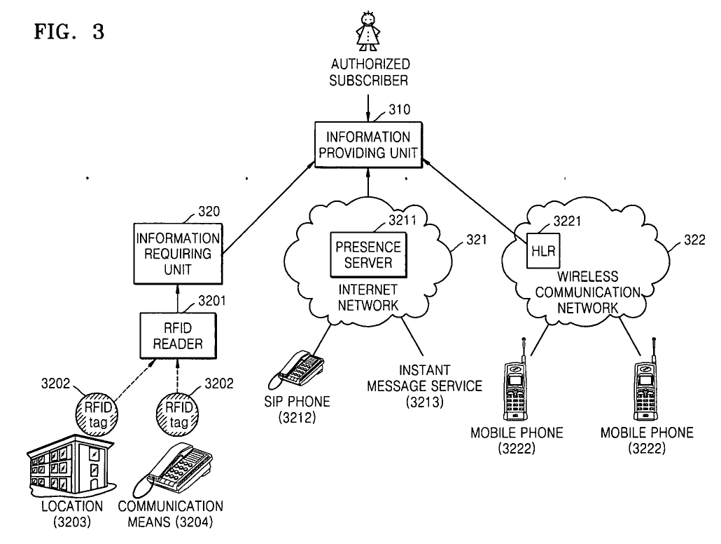

FIG. 3 illustrates the structure of a wired/wireless/Internet integrated network for providing presence information using the RFID technique.

Referring to FIG. 3, the wired/wireless/Internet integrated network includes an information providing unit 310, an information acquiring unit 320, an Internet network 321, a wireless communication network 322, an RFID reader 3201, and a plurality of RFID tags 3202.

The information providing unit 310 receives a subscriber's presence information from a presence server 3211 on an Internet network 321 and a Home Location Register (HLR) 3221 on the wireless communication network 322, as well as from the presence information acquiring unit 320.

The subscriber's presence information can be directly acquired without using the RFID technique, from the Internet network 321 and the wireless communication network 322. As such, information which can be directly acquired from a network is called dynamic presence information.

Generally, a subscriber's presence information cannot be directly acquired from different networks except for from the Internet network 321 and the wireless communication network 322. According to the an embodiment of present invention, it is possible to directly acquire a subscriber's presence information from an arbitrary network using the RFID technique.

Then, the information acquiring unit 320 acquires identification information stored in the RFID tags 3202 from the RFID reader 3201. The RFID tags 3201 are distributed to a location 3203 and a communication device 3204. Identification information stored in each RFID tag 3201 is location information if the RFID tag 3202 is attached to a location (for example, a building), and is a number of a communication device if the RFID tag 3202 is attached to a communication device.

The RFID reader 3201 reads identification information stored in each RFID tag 3202 from the RFID tag 3202. The RFID reader 3201 belongs to a subscriber. The RFID reader 3201 reads identification information stored in an RFID tag 3202 located in its communication region.

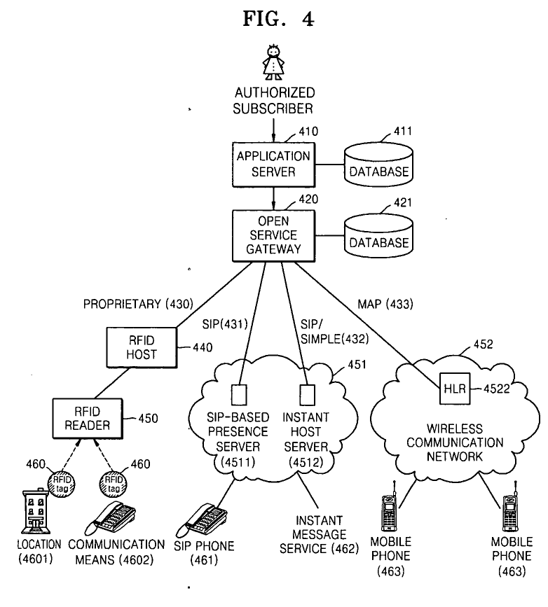

FIG. 4 illustrates a wired/wireless/Internet integrated network system for providing presence information using the RFID technique.

Referring to FIG. 4, the wired/wireless/Internet integrated network system includes an application server 410, an open service gateway 420, an RFID host 440, an RFID reader 450, an Internet network 451, and a wireless communication network 452.

The application server 410 includes a database 411 so that presence-based services can be hosted on the wired/wireless/Internet integrated network.

The open service gateway 420 includes a database 421 for storing presence information, and provides an open service function, a link function 430 with respect to an RFID host, a link function 431 with respect to a Session Initiation Protocol (SIP)-based presence server 4511, a link function 432 with respect to a server for hosting an instant messaging service, and a link function 433 with respect to a mobile communication network.

On the Internet network 451, a SIP-based presence server 4511 for processing status information of a SIP phone 461 and an instant host server 4512 for hosting an instant messaging service are provided.

On the wireless communication network 452, a home location register (HLR) 4522 containing status information of a mobile phone 463 is provided.

RFID tags 460 are attached to a general telephone 4602 connected to a network that does not support status information and a representative location 4601 representing a subscriber's activity, location, and privacy information, from among presence attributes. The subscriber must have the RFID reader 450 for reading information from each RFID tag 460. Also, the RFID host 440 stores information read from the RFID reader 450.

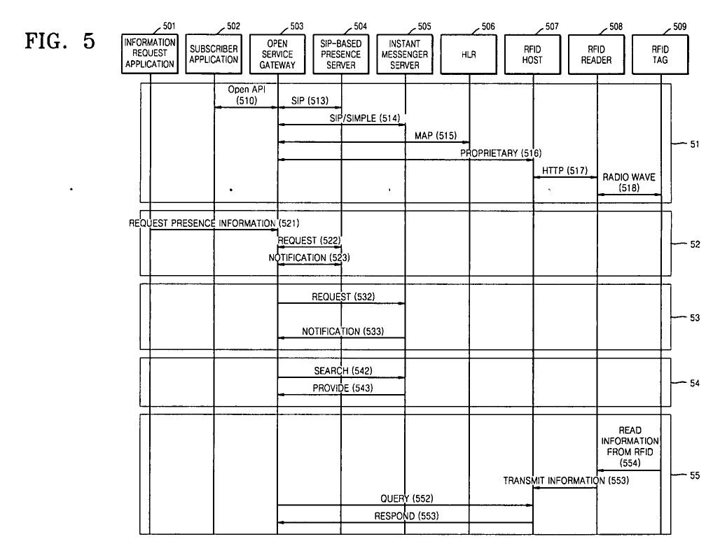

FIG. 5 is a view for explaining a method of providing presence information using an open service interface and the RFID technique. Referring to FIG. 5, a block 51 shows the flow of a method for registering presence information. A block 52 shows the flow of a method for obtaining SIP phone status information of the presence information. A block 53 shows the flow of a method for obtaining status information of an instance message from among the presence information. A block 54 shows the flow of a method for obtaining mobile phone status information from among the presence information.

Referring to FIG. 5, an interface between a watcher application 501, a subscriber application 502, and an open service gateway 503 is an open application programming interface (Open API) 510.

Referring to the block 51, it is assumed that the open service gateway 503 is linked with a server existing in a network by a protocol provided by a network provider, is linked with a SIP-based presence server in an IP network by SIP 513, is linked with an instant messenger server in an IP network by SIP/SIMPLE 514, is linked with an HLR in a mobile communication network by MAP 515, and is linked with an RFID host by an independent interface 516.

Referring to the block 52, the information request application 501 also requests presence information of an interested subscriber (operation 521). If a request for presence information is received, the open service gateway 503 obtains the newest version of presence information from an actual network. In order to obtain status information of an SIP terminal, the open service gateway 503 receives status information from an SIP-based presence server 504. Referring to the block 53, in order to obtain status information of an instant messenger, the open service gateway 503 receives status information from the instant messenger server 505 (operation 533).

Referring to the block 54, in order to obtain status of a mobile phone, the open service gateway 503 sends a search message to the HLR 506 (operation 542), receives a response from the HLR 506 (operation 543), queries the RFID host 507 (operation 552), and receives a response from the RFID host 507 (operation 553).

Referring to the block 55, an RFID reader 508 acquires location information, communication means information, etc. by using radio wave 518, from an RFID tag 509 attached to a general telephone, etc. that is connected to a network that does not support status information and a representative location representing activity, location, and privacy information from among presence attributes (operation 554), and transfers the location information, the communication means information, etc. to the RFID host 507 through the wireless Internet, etc. (operation 555). The RFID host 507 stores location information or communication means information, etc. in a database according to a policy defined in the open service gateway 503, so as to respond to a query received from the open service gateway 503 (operations 552 and 553).

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, the presence information providing apparatus and method according to the present invention have the following effects.

When subscriber's presence information is collected and provided using an open service interface in a wired/wireless/Internet integrated network, according to an existing network structure, the reliability of the presence information depends on the subscriber's intension. Since the presence open service must be updated by a subscriber whenever the subscriber's presence information changes, basic limitations exist in developing abundant and useful applications. According to the present invention, since presence information is acquired in its original form, from a network, it is possible to provide reliable presence information updated in real time. Also, service providers can develop various reliable presence-based services based on a reliable subscriber's presence information.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A presence information providing apparatus comprising:
an information requiring unit receiving identification information stored in an RFID (Radio Frequency Identification) tag from the RFID reader belonging to a subscriber, and acquiring a subscriber's presence information based on the identification information; and
an information providing unit providing the subscriber's presence information acquired by the information acquiring unit when a request for an authorized subscriber's information is received.

2. The presence information providing apparatus of claim 1, wherein the RFID tag is distributed to a communication device, and the identification information stored in the RFID tag further includes a communication device number.

3. The presence information providing apparatus of claim 1, wherein the RFID tag is distributed to a location, and the identification information stored in the RFID tag further includes representative location information.

4. A presence information providing method comprising:
receiving identification information stored in an RFID tag from the RFID reader belonging to a subscriber, and acquiring a subscriber's presence information based on the identification information; and
providing the subscriber's presence information acquired by the information acquiring unit when a request for an authorized subscriber's information is received.

5. The presence information providing method of claim 4, wherein the RFID tag is distributed to a communication device, and the identification information stored in the RFID tag further includes a communication device number.

6. The presence information providing method of claim 4, wherein the RFID tag is distributed to a location, and the identification information stored in the RFID tag further includes representative location information.

7. A presence information providing system comprising:
an RFID host receiving identification information stored in an RFID tag from the RFID reader belonging to a subscriber, and acquiring a subscriber's presence information based on the identification information; and
an open service gateway providing the subscriber's presence information acquired by the RFID host when a request for an authorized subscriber's information is received.
